(19) United States
(12) Patent Application Publication
(10) Pub. No.: US 2025/0273732 A1
(43) Pub. Date: Aug. 28, 2025

(54) SOLID-STATE BATTERY WITH MULTILAYER SOLID-STATE ELECTROLYTE

(71) Applicant: GM GLOBAL TECHNOLOGY OPERATIONS LLC, DETROIT, MI (US)

(72) Inventors: Shaomao Xu, Sterling Heights, MI (US); Chuanlong Wang, Troy, MI (US); Xiaosong Huang, Novi, MI (US)

(21) Appl. No.: 18/588,663

(22) Filed: Feb. 27, 2024

(51) Int. Cl. H01M 10/0562; B60L 50/64; H01M 4/02; H01M 4/36

(52) U.S. Cl. CPC H01M 10/0562; H01M 4/366; B60L 50/64; H01M 2004/027; H01M 2004/028; H01M 2300/0068

(57) ABSTRACT

Aspects of the disclosure include a solid-state battery with a multilayer solid-state electrolyte. An exemplary vehicle includes an electric motor and a battery pack electrically coupled to the electric motor. The battery pack includes a battery cell that includes an anode current collector and a composite anode layer having an anode active material embedded with a first low-voltage solid-state electrolyte. The battery pack includes a cathode current collector and a composite cathode layer having a cathode active material embedded with a first high-voltage solid-state electrolyte. A multilayer solid-state electrolyte is between the composite anode layer and the composite cathode layer. The multilayer solid-state electrolyte includes a second low-voltage solid-state electrolyte, a second high-voltage solid-state electrolyte, and an interlayer solid-state electrolyte directly between the second low-voltage solid-state electrolyte and the second high-voltage solid-state electrolyte.

### INTRODUCTION

The present disclosure relates to battery cell manufacturing, and particularly to a solid-state battery (SSB) with multilayer solid-state electrolyte (SSE).

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

The lithium-ion battery (LIB) has become one of the most common battery chemistries for these and other applications. A typical lithium-ion battery consists of three main components: an anode, often made of graphite, a cathode, often made of lithium cobalt oxide (LiCoO₂), lithium manganese oxide (LiMn₂O₄), or lithium iron phosphate (LiFePO₄), and a liquid electrolyte, commonly a lithium salt dissolved in a solvent, such as ethylene carbonate and dimethyl carbonate. The electrolyte facilitates the movement of lithium ions between the anode and cathode during charge and discharge.

Recently, solid-state batteries have emerged as a potential next-generation replacement for lithium-ion batteries. In a solid-state battery, the conventional liquid electrolyte is substituted with a solid-state material (e.g., a solid electrolyte, SE). The solid electrolyte can take various forms, including ceramics, polymers, or a combination of both. Solid-state batteries offer various advantages over liquid electrolyte-based batteries, such as relatively higher energy densities, longer cycle life, wider operational temperature ranges, and greater flexibility in design due to their natively thinner and lighter architectures.

### SUMMARY

In one exemplary embodiment a vehicle includes an electric motor and a battery pack electrically coupled to the electric motor. The battery pack includes a battery cell that includes an anode current collector and a composite anode layer having an anode active material embedded with a first low-voltage solid-state electrolyte. The battery pack includes a cathode current collector and a composite cathode layer having a cathode active material embedded with a first high-voltage solid-state electrolyte. A multilayer solid-state electrolyte is between the composite anode layer and the composite cathode layer. The multilayer solid-state electrolyte includes a second low-voltage solid-state electrolyte, a second high-voltage solid-state electrolyte, and an interlayer solid-state electrolyte directly between the second low-voltage solid-state electrolyte and the second high-voltage solid-state electrolyte.

In addition to one or more of the features described herein, in some embodiments, the first low-voltage solid-state electrolyte includes a material that is electrochemically stable at a voltage measured relative to a lithium electrode reference that is below 2.5 V.

In some embodiments, the first low-voltage solid-state electrolyte includes one or more low-voltage stable solid-state electrolyte material(s). Some examples of these materials include lithium lanthanum zirconate (LLZO), lithium phosphorus oxynitride (LiPON), lithium super ionic conductor (LISICON), and lithium germanium sulfide (LGS).

In some embodiments, the first high-voltage solid-state electrolyte includes a material that is electrochemically stable at a voltage measured relative to a lithium electrode reference that is above 3.0 V.

In some embodiments, the first high-voltage solid-state electrolyte includes one or more high-voltage stable solid-state electrolyte material(s). Some examples of these materials include lithium aluminum titanium phosphate (LATP), lithium aluminum germanium phosphate (LAGP), and lithium lanthanum titanate (LLTO).

In some embodiments, a content of the first low-voltage solid-state electrolyte in the anode active material is between 10 percent and 40 percent by weight.

In some embodiments, a content of the first high-voltage solid-state electrolyte in the cathode active material is between 10 percent and 40 percent by weight.

In another exemplary embodiment a battery cell includes an anode current collector and a composite anode layer having an anode active material embedded with a first low-voltage solid-state electrolyte. The battery pack includes a cathode current collector and a composite cathode layer having a cathode active material embedded with a first high-voltage solid-state electrolyte. A multilayer solid-state electrolyte is between the composite anode layer and the composite cathode layer. The multilayer solid-state electrolyte includes a second low-voltage solid-state electrolyte, a second high-voltage solid-state electrolyte, and an interlayer solid-state electrolyte directly between the second low-voltage solid-state electrolyte and the second high-voltage solid-state electrolyte.

In some embodiments, the first low-voltage solid-state electrolyte includes a material that is electrochemically stable at a voltage measured relative to a lithium electrode reference that is below 2.5 V.

In some embodiments, the first low-voltage solid-state electrolyte includes one or more low-voltage stable solid-state electrolyte(s) such as, for example, one or more of lithium lanthanum zirconate (LLZO), lithium phosphorus oxynitride (LiPON), lithium super ionic conductor (LISICON), and lithium germanium sulfide (LGS), although other low-voltage stable solid-state electrolytes are within the contemplated scope of this disclosure.

In some embodiments, the first high-voltage solid-state electrolyte includes a material that is electrochemically stable at a voltage measured relative to a lithium electrode reference that is above 3.0 V.

In some embodiments, the first high-voltage solid-state electrolyte includes one or more high-voltage stable solid-state electrolyte(s) such as, for example, one or more of lithium aluminum titanium phosphate (LATP), lithium aluminum germanium phosphate (LAGP), and lithium lanthanum titanate (LLTO), although other high-voltage stable solid-state electrolytes are within the contemplated scope of this disclosure.

In some embodiments, a content of the first low-voltage solid-state electrolyte in the anode active material is between 10 percent and 40 percent by weight.

In some embodiments, a content of the first high-voltage solid-state electrolyte in the cathode active material is between 10 percent and 40 percent by weight.

In yet another exemplary embodiment a method can include forming an anode current collector, forming a composite anode layer having an anode active material embedded with a first low-voltage solid-state electrolyte, forming a cathode current collector, forming a composite cathode layer having a cathode active material embedded with a first high-voltage solid-state electrolyte, and forming a multilayer solid-state electrolyte between the composite anode layer and the composite cathode layer. The multilayer solid-state electrolyte includes a second low-voltage solid-state electrolyte, a second high-voltage solid-state electrolyte, and an interlayer solid-state electrolyte directly between the second low-voltage solid-state electrolyte and the second high-voltage solid-state electrolyte.

In some embodiments, the first low-voltage solid-state electrolyte includes a material that is electrochemically stable at a voltage measured relative to a lithium electrode reference that is below 2.5 V.

In some embodiments, the first low-voltage solid-state electrolyte includes one or more of lithium lanthanum zirconate (LLZO), lithium phosphorus oxynitride (LiPON), lithium super ionic conductor (LISICON), and lithium germanium sulfide (LGS).

In some embodiments, the first high-voltage solid-state electrolyte includes a material that is electrochemically stable at a voltage measured relative to a lithium electrode reference that is above 3.0 V.

In some embodiments, the first high-voltage solid-state electrolyte includes one or more of lithium aluminum titanium phosphate (LATP), lithium aluminum germanium phosphate (LAGP), and lithium lanthanum titanate (LLTO).

In some embodiments, the method includes forming an anode-side interlayer directly between the composite anode layer and the second low-voltage solid-state electrolyte.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the battery cell shown in FIG. 2A in accordance with one or more embodiments;

FIG. 2C is a detailed view of the battery cell shown in FIG. 2B in accordance with one or more embodiments;

FIG. 3 is an alternative battery configuration in accordance with one or more embodiments; and

FIG. 4 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems. For example, solid-state batteries have been increasingly investigated as a potential next-generation replacement for conventional batteries (e.g., lithium-ion based batteries, such as LFP batteries). In a solid-state battery, the liquid electrolyte is replaced with a solid electrolyte and the anode is typically made of an alkali metal, often lithium metal, although other alkali metals are possible (e.g., Na, K, Zn, and Mg).

Challenges remain, however, in designing and manufacturing solid-state batteries with solid electrolytes. In particular, while solid-state electrolytes (SSE) can offer relatively high ionic conductivity values, SSEs can suffer from poor electrochemical and chemical stability. For example, many SSEs can be susceptible to decomposition under high/low potentials (that is, potentials above 5 V and below 2 V, respectively), meaning that these electrolytes are natively restricted to somewhat narrow operational voltage windows. Moreover, SSEs are largely incompatible with lithium metal, which is highly desired for next-generation batteries.

This disclosure introduces a new solid-state battery and a method of manufacturing the same. Rather than relying on a single solid-state electrolyte, a multilayer solid-state electrolyte is leveraged to enable a natively wider operational voltage window. In some embodiments, different solid-state electrolyte materials are incorporated directly into the anode and cathode, respectively, thereby providing ion conductive pathways in the resulting composite electrodes. Additional anode-compatible SSE(s) (e.g., a low-voltage SSE) and cathode-compatible SSE(s) (e.g., a high-voltage SSE) are then laminated against the composite anode and composite cathode, respectively. An interlayer SSE is sandwiched between the coated composite electrodes to facilitate ion (e.g., Li+) transport. Notably, the combined use of multiple SSE layers leads to an increased battery operational voltage window and provides additional options on selecting electrolytes with high ionic conductivity.

A solid-state battery manufactured with a multilayer solid-state electrolyte in accordance with one or more embodiments offers several technical advantages over prior solid-state batteries. Notably, the solid-state batteries described herein are natively compatible over a relatively wider operational voltage range than available using single SSE chemistries, and in particular enable high voltage applications (that is, voltages in excess of 5 V). Other advantages are possible. For example, solid-state batteries described herein enable the use of lithium metal anodes with conventionally incompatible SSEs, as only the embedded SSE within the anode needs to be compatible with lithium metal. In other words, material selection for the additional anode-compatible SSE(s) laminated onto the composite anode is greatly relaxed.

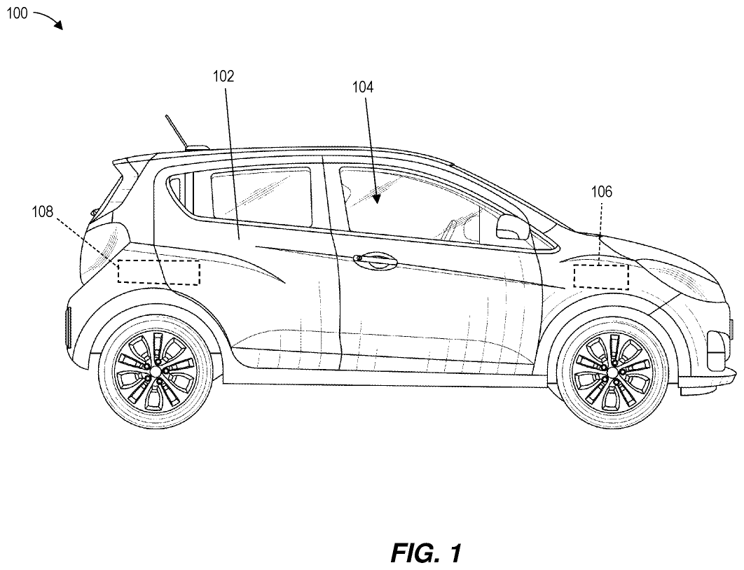

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

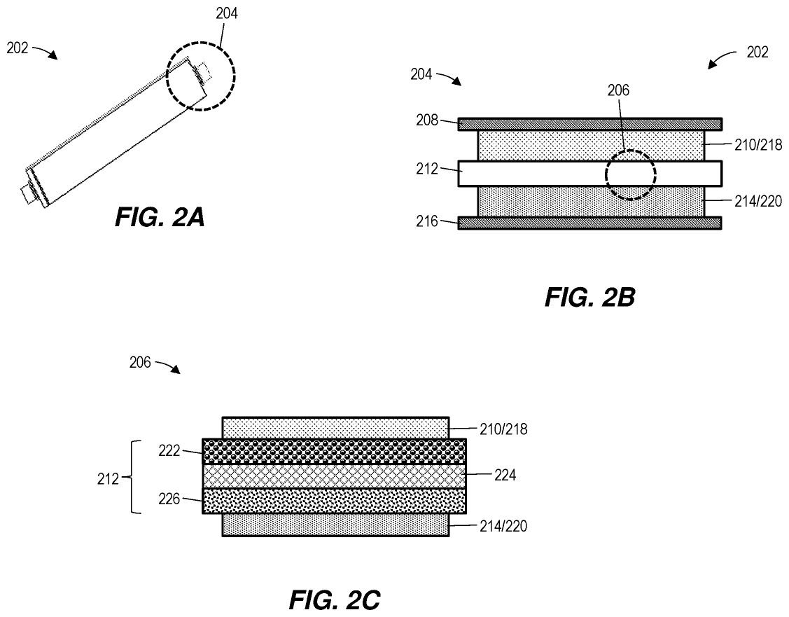

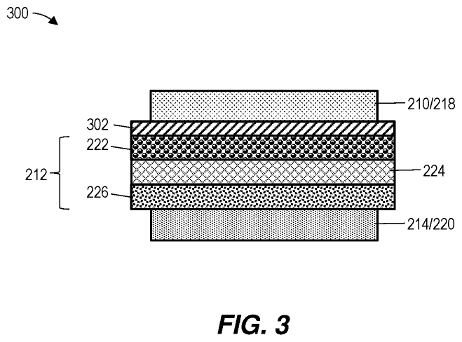

As will be detailed herein, the battery pack 108 includes one or more battery cells and/or battery pouches having a new solid-state battery design that includes a multilayer solid-state electrolyte. An example battery cell is shown in FIG. 2A. A detailed view of an electrode stack within the battery cell of FIG. 2A is shown in FIG. 2B. A detailed view of a multilayer solid-state electrolyte of the electrode stack of FIG. 2B is shown in FIG. 2C. An alternative solid-state electrolyte is shown in FIG. 3.

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the battery cell 202 shown in FIG. 2A in accordance with one or more embodiments. FIG. 2C illustrates a detailed view 206 of the battery cell 202 shown in FIG. 2B in accordance with one or more embodiments.

As shown in FIG. 2B, the battery cell 202 includes, from top to bottom, an anode current collector 208, a composite anode layer 210, a multilayer solid-state electrolyte 212, a composite cathode layer 214, and a cathode current collector 216. The multilayer solid-state electrolyte 212 is discussed in greater detail with respect to FIG. 2C.

The anode current collector 208 and the cathode current collector 216 can be made of sheets or foils of conductive metal. For example, the cathode current collector 216 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 216 is made of aluminum foil. The anode current collector 208 can include, for example, copper foil and/or one or more graphene layers.

In some embodiments, the composite anode layer 210 includes an anode active material embedded with a first low-voltage solid-state electrolyte 218. As used herein, a “low-voltage” solid-state electrolyte refers to an electrolyte having a stable structure (electrochemically stable) at a voltage measured relative to a lithium electrode reference that is below 2.5 V, for example, 0.1 V to 0.8 V. Example materials for low-voltage solid-state electrolytes include lithium lanthanum zirconate (Li₇La₃Zr₂Oi₂, LLZO), lithium phosphorus oxynitride (Li₃PO₄, LiPON), lithium super ionic conductor (LISICON), and lithium germanium sulfide (Li₄GeS₄, LGS), although other low-voltage solid-state electrolytes are within the contemplated scope of this disclosure. In some embodiments, the content of the first low-voltage solid-state electrolyte 218 in the anode active material (together defining the composite anode layer 210) is between 10 percent and 40 percent by weight. The anode active material is not meant to be particularly limited, but can include, for example, lithium metal, activated carbon powder, graphite, silicon, silicon-graphite composites, tin, tin oxide (SnO₂), lithium titanate (Li₄Ti₅Oi₂, LTO), and combinations thereof. In some embodiments, the composite anode layer 210 includes lithium metal and at least one of LLZO, LiPON, LISICON, and LGS.

In some embodiments, the composite cathode layer 214 includes a cathode active material embedded with a first high-voltage solid-state electrolyte 220. As used herein, a “high-voltage” solid-state electrolyte refers to an electrolyte having a stable structure (electrochemically stable) at a voltage measured relative to a lithium electrode reference that is above 3.0 V, for example, 4.0 V to 10.0 V. Example materials for high-voltage solid-state electrolytes include lithium aluminum titanium phosphate (Li_{1.3}Al_{0.3}Ti_{1.7}(PO₄)₃, LATP), lithium aluminum germanium phosphate (Li_{1.5}Al_{0.5}Ge_{1.5}(PO₄)₃, LAGP), and lithium lanthanum titanate (LiₓLa_{(2-x)/3}TiO₃, where x is 0.2 to 0.3, LLTO), although other high-voltage solid-state electrolytes are within the contemplated scope of this disclosure. In some embodiments, the content of the high-voltage solid-state electrolyte 220 in the cathode active material (together defining the composite cathode layer 214) is between 10 percent and 40 percent by weight. The cathode active material is not meant to be particularly limited, but can include, for example, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), and lithium manganese oxide (LMO).

As shown in FIG. 2C, the multilayer solid-state electrolyte 212 includes, from top to bottom, a second low-voltage solid-state electrolyte 222, an interlayer solid-state electrolyte 224, and a second high-voltage solid-state electrolyte 226, configured and arranged as shown.

In some embodiments, the second low-voltage solid-state electrolyte 222 is coated onto the composite anode layer 210. The second low-voltage solid-state electrolyte 222 can be made of the same or from different materials as the first low-voltage solid-state electrolyte 218. Notably, material selection for the second low-voltage solid-state electrolyte 222 is relaxed as compared to the first low-voltage solid-state electrolyte 218, as the first low-voltage solid-state electrolyte 218 ensures compatibility with the anode active material. The second low-voltage solid-state electrolyte 222 can include, for example, LLZO, LiPON, LISICON, and LGS, as well as typically incompatible materials such as lithium germanium phosphorus sulfide (LGPS), lithium thiophosphate (Li₃PS₄), lithium argyrodite (Li₆PS₅Cl), and the low temperature phase glass-ceramic electrolyte Li₇P₂S₈I. In some embodiments, the second low-voltage solid-state electrolyte 222 is a composite SSE that includes a polymer material, such as, for example, polyethylene oxide (PEO), polyacrylonitrile (PAN), and polyvinylidene fluoride (PVDF).

In some embodiments, the interlayer solid-state electrolyte 224 is laminated between the second low-voltage solid-state electrolyte 222 and the second high-voltage solid-state electrolyte 226. In some embodiments, the interlayer solid-state electrolyte 224 is made of a material selected to improve interfacial contact ato facilitate ion (e.g., Li⁺) transport. Example materials include polymers and gels such as PEO, PVDF, polyethylene carbonate (PEC), and polyvinylidene fluoride-co-hexafluoropropylene (PVDF-HFP), although other interlayer materials are within the contemplated scope of this disclosure.

In some embodiments, the second high-voltage solid-state electrolyte 226 is coated onto the composite cathode layer 214. The second high-voltage solid-state electrolyte 226 can be made of the same or from different materials as the first high-voltage solid-state electrolyte 220. Notably, material selection for the second high-voltage solid-state electrolyte 226 is relaxed as compared to the first high-voltage solid-state electrolyte 220, as the first high-voltage solid-state electrolyte 220 ensures compatibility with the cathode active material. The second high-voltage solid-state electrolyte 226 can include, for example, LATP, LAGP, and LLTO, as well as typically incompatible materials such as LLZO, LISICON, LiPON, etc. In some embodiments, the second high-voltage solid-state electrolyte 226 is a composite SSE that includes a polymer material, such as, for example, PEO, PAN, and PVDF.

FIG. 3 illustrates an alternative battery configuration 300 in accordance with one or more embodiments. The battery configuration 300 is constructed in a similar manner and from similar materials as that previously discussed with respect to FIGS. 2A, 2B, and 2C, except that the battery configuration 300 introduces an anode-side interlayer 302.

In some embodiments, the anode-side interlayer 302 is positioned directly between the composite anode layer 210 and the second low-voltage solid-state electrolyte 222 (as shown). The anode-side interlayer 302 can be coated onto either (or both) layers, or can be fixed via pressure and/or thermal lamination. In some embodiments, the anode-side interlayer 302 is made of a material selected to improve lithium cycling performance. Such a configuration is useful in embodiments where a lithium metal anode is utilized. The anode-side interlayer 302 can include, for example, lithium nitrate (LiNO₃) and lithium fluoride (LiF), although other lithium-metal anode compatible materials are within the contemplated scope of this disclosure.

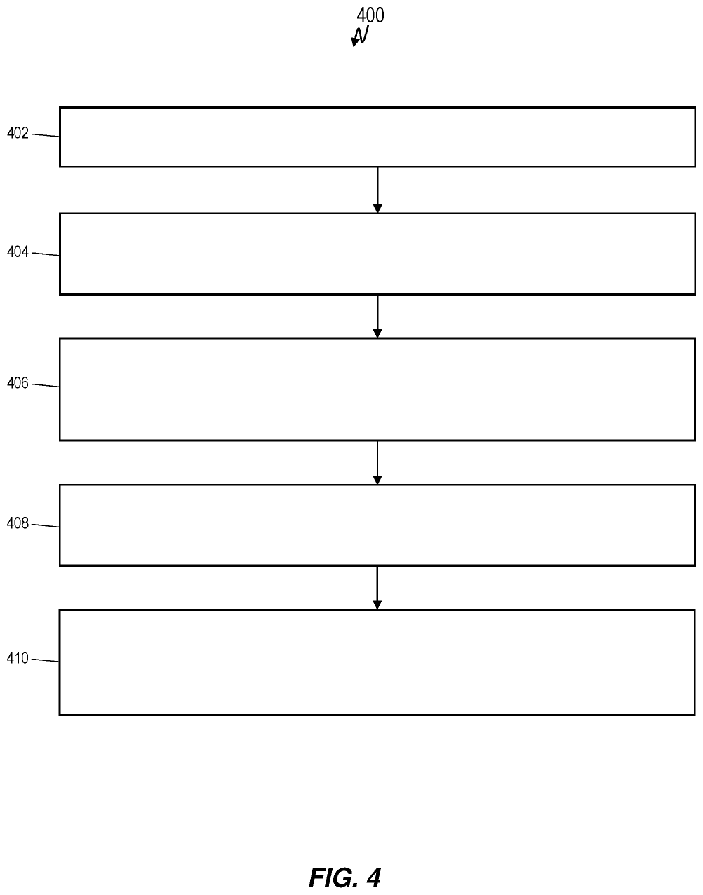

Referring now to FIG. 4, a flowchart 400 for manufacturing a solid-state battery with a multilayer solid-state electrolyte is generally shown according to an embodiment. The flowchart 400 is described in reference to FIGS. 1-3 and may include additional steps not depicted in FIG. 4. Although depicted in a particular order, the blocks depicted in FIG. 4 can be rearranged, subdivided, and/or combined.

At block 402, the method includes forming an anode current collector.

At block 404, the method includes forming a composite anode layer having an anode active material embedded with a first low-voltage solid-state electrolyte. In some embodiments, the composite anode layer is in direct contact with the anode current collector.

In some embodiments, the first low-voltage solid-state electrolyte includes a material that is electrochemically stable at a voltage measured relative to a lithium electrode reference that is below 2.5 V. In some embodiments, the first low-voltage solid-state electrolyte includes one or more of LLZO, LiPON, LISICON, and LGS. In some embodiments, a content of the first low-voltage solid-state electrolyte in the anode active material is between 10 percent and 40 percent by weight.

At block 406, the method includes forming a cathode current collector.

At block 408, the method includes forming a composite cathode layer having a cathode active material embedded with a first high-voltage solid-state electrolyte. In some embodiments, the composite cathode layer is in direct contact with the cathode current collector.

In some embodiments, the first high-voltage solid-state electrolyte includes a material that is electrochemically stable at a voltage measured relative to a lithium electrode reference that is above 3.0 V. In some embodiments, the first high-voltage solid-state electrolyte includes one or more of LATP, LAGP, and LLTO. In some embodiments, a content of the first high-voltage solid-state electrolyte in the cathode active material is between 10 percent and 40 percent by weight.

At block 410, the method includes forming a multilayer solid-state electrolyte between the composite anode layer and the composite cathode layer. In some embodiments, the multilayer solid-state electrolyte includes a second low-voltage solid-state electrolyte, a second high-voltage solid-state electrolyte, and an interlayer solid-state electrolyte directly between the second low-voltage solid-state electrolyte and the second high-voltage solid-state electrolyte.

In some embodiments, the method further includes forming an anode-side interlayer directly between the composite anode layer and the second low-voltage solid-state electrolyte.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a battery cell, the battery cell comprising:
an anode current collector;
a composite anode layer comprising an anode active material embedded with a first low-voltage solid-state electrolyte, the composite anode layer in direct contact with the anode current collector;
a cathode current collector;
a composite cathode layer comprising a cathode active material embedded with a first high-voltage solid-state electrolyte, the composite cathode layer in direct contact with the cathode current collector; and
a multilayer solid-state electrolyte between the composite anode layer and the composite cathode layer, the multilayer solid-state electrolyte comprising:
a second low-voltage solid-state electrolyte;
a second high-voltage solid-state electrolyte; and
an interlayer solid-state electrolyte directly between the second low-voltage solid-state electrolyte and the second high-voltage solid-state electrolyte.

2. The vehicle of claim 1, wherein the first low-voltage solid-state electrolyte comprises a material that is electrochemically stable at a voltage measured relative to a lithium electrode reference that is below 2.5 V.

3. The vehicle of claim 2, wherein the first low-voltage solid-state electrolyte comprises one or more of lithium lanthanum zirconate (LLZO), lithium phosphorus oxynitride (LiPON), lithium super ionic conductor (LISICON), and lithium germanium sulfide (LGS).

4. The vehicle of claim 1, wherein the first high-voltage solid-state electrolyte comprises a material that is electrochemically stable at a voltage measured relative to a lithium electrode reference that is above 3.0 V.

5. The vehicle of claim 4, wherein the first high-voltage solid-state electrolyte comprises one or more of lithium aluminum titanium phosphate (LATP), lithium aluminum germanium phosphate (LAGP), and lithium lanthanum titanate (LLTO).

6. The vehicle of claim 1, wherein a content of the first low-voltage solid-state electrolyte in the anode active material is between 10 percent and 40 percent by weight.

7. The vehicle of claim 1, wherein a content of the first high-voltage solid-state electrolyte in the cathode active material is between 10 percent and 40 percent by weight.

8. A battery cell comprising:
an anode current collector;
a composite anode layer comprising an anode active material embedded with a first low-voltage solid-state electrolyte, the composite anode layer in direct contact with the anode current collector;
a cathode current collector;
a composite cathode layer comprising a cathode active material embedded with a first high-voltage solid-state electrolyte, the composite cathode layer in direct contact with the cathode current collector; and
a multilayer solid-state electrolyte between the composite anode layer and the composite cathode layer, the multilayer solid-state electrolyte comprising:
a second low-voltage solid-state electrolyte;
a second high-voltage solid-state electrolyte; and
an interlayer solid-state electrolyte directly between the second low-voltage solid-state electrolyte and the second high-voltage solid-state electrolyte.

9. The battery cell of claim 8, wherein the first low-voltage solid-state electrolyte comprises a material that is electrochemically stable at a voltage measured relative to a lithium electrode reference that is below 2.5 V.

10. The battery cell of claim 9, wherein the first low-voltage solid-state electrolyte comprises one or more of lithium lanthanum zirconate (LLZO), lithium phosphorus oxynitride (LiPON), lithium super ionic conductor (LISICON), and lithium germanium sulfide (LGS).

11. The battery cell of claim 8, wherein the first high-voltage solid-state electrolyte comprises a material that is electrochemically stable at a voltage measured relative to a lithium electrode reference that is above 3.0 V.

12. The battery cell of claim 11, wherein the first high-voltage solid-state electrolyte comprises one or more of lithium aluminum titanium phosphate (LATP), lithium aluminum germanium phosphate (LAGP), and lithium lanthanum titanate (LLTO).

13. The battery cell of claim 8, wherein a content of the first low-voltage solid-state electrolyte in the anode active material is between 10 percent and 40 percent by weight.

14. The battery cell of claim 8, wherein a content of the first high-voltage solid-state electrolyte in the cathode active material is between 10 percent and 40 percent by weight.

15. A method comprising:
forming an anode current collector;
forming a composite anode layer comprising an anode active material embedded with a first low-voltage solid-state electrolyte, the composite anode layer in direct contact with the anode current collector;
forming a cathode current collector;
forming a composite cathode layer comprising a cathode active material embedded with a first high-voltage solid-state electrolyte, the composite cathode layer in direct contact with the cathode current collector; and
forming a multilayer solid-state electrolyte between the composite anode layer and the composite cathode layer, the multilayer solid-state electrolyte comprising:
a second low-voltage solid-state electrolyte;
a second high-voltage solid-state electrolyte; and
an interlayer solid-state electrolyte directly between the second low-voltage solid-state electrolyte and the second high-voltage solid-state electrolyte.

16. The method of claim 15, wherein the first low-voltage solid-state electrolyte comprises a material that is electrochemically stable at a voltage measured relative to a lithium electrode reference that is below 2.5 V.

17. The method of claim 16, wherein the first low-voltage solid-state electrolyte comprises one or more of lithium lanthanum zirconate (LLZO), lithium phosphorus oxynitride (LiPON), lithium super ionic conductor (LISICON), and lithium germanium sulfide (LGS).

18. The method of claim 15, wherein the first high-voltage solid-state electrolyte comprises a material that is electrochemically stable at a voltage measured relative to a lithium electrode reference that is above 3.0 V.

19. The method of claim 18, wherein the first high-voltage solid-state electrolyte comprises one or more of lithium aluminum titanium phosphate (LATP), lithium aluminum germanium phosphate (LAGP), and lithium lanthanum titanate (LLTO).

20. The method of claim 15, further comprising forming an anode-side interlayer directly between the composite anode layer and the second low-voltage solid-state electrolyte.
